(19) United States
(12) Patent Application Publication
(10) Pub. No.: US 2018/0209785 A1
(43) Pub. Date: Jul. 26, 2018

(54) VEHICLE WHEEL ALIGNMENT APPARATUS AND SYSTEM, AND RELATED METHODS THEREOF

(71) Applicant: BIG RIG CUSTOM TOOLING, LLC, Meridian, TX (US)

(72) Inventors: CHANCE A. FINSTAD, MERIDIAN, TX (US); DANIEL T. ASHE, STOCKHOLM (SE); JOHN ASHAL, TUCSON, AZ (US)

(21) Appl. No.: 15/879,298

(22) Filed: Jan. 24, 2018

Related U.S. Application Data
(60) Provisional application No. 62/449,952, filed on Jan. 24, 2017.

(51) Int. Cl. G01B 11/275; B33Y 10/00; B33Y 80/00; B29C 64/118

(52) U.S. Cl. CPC G01B 11/2755; B33Y 10/00; G01B 2210/14; B29C 64/118; B33Y 80/00

(57) ABSTRACT

A vehicle wheel alignment system has a frame member and an optical device mounted to the frame member. At least one shaft connected to the frame member, wherein the at least one shaft is positionable against a rim of the vehicle wheel, wherein the at least one shaft is constructed from a non-metal material. The system may allow for vehicle wheel alignments without scratching the face of the rim. Related methods, apparatuses, and systems are provided.

### CROSS REFERENCE TO RELATED APPLICATION

This application claims benefit of U.S. Provisional Application Ser. No. 62/449,952 entitled, “Vehicle Wheel Alignment Apparatus and System, and Related Methods Thereof”, filed Jan. 24, 2017, the entire disclosure of which is incorporated herein by reference.

### FIELD OF THE DISCLOSURE

The present disclosure is generally related to wheel alignment and more particularly is related to vehicle wheel alignment apparatus, system, and method.

### BACKGROUND OF THE DISCLOSURE

Proper alignment of vehicle wheels is necessary to ensure safe operation of the vehicle and proper handling of the vehicle, and to prevent premature degradation of the tire. To ensure proper alignment of wheels on large trucks, such as tractor trailers, and similarly sized large vehicles, such as busses, a camera-based system is used. The camera system is first attached to the exterior side of the rim of each wheel on the vehicle. Then, various hardware and software devices are used to determine the positioning of the vehicle wheels and, if necessary, identify how the wheel should be adjusted to correct alignment.

When using the camera system, it is imperative that the camera is mounted precisely and correctly to the rim, since any inadvertent fluctuation or skewed mounting of the camera to the rim will hinder achieving accurate alignment measurements. As such, the camera is commonly mounted to a framework which is then secured to the rim, usually with a mount that connects to the exterior edge of the rim or using a plurality of metal shafts, often three or more, which are positioned over lug nuts of the rim. When the metal shafts are used, the metal shafts, which are also known as adapters within the industry, are positioned over the lug nuts and the terminating ends of the metal shafts make contact with the rim face. Then, magnets within the metal shafts are activated to magnetically contact the exterior face of the lug nuts, e.g., magnetically biasing the magnets to the exterior face of the lug nuts, which biases the metal shafts towards the rim to forcefully contact the terminating ends of the metal shafts against the exterior face of the rim. The use of strong magnets is imperative to create the strong magnetic force sufficient enough to retain the metal shafts against the exterior face of the rim in an immovable position, such that there is no inadvertent movement, positional movements of the metal shafts relative to the rim.

While this type of conventional alignment system has been used successfully in many applications, it has many drawbacks. For one, when the metal shafts contact the rim face, they often scratch the rim face and routinely cause deep, visible scratches to the rim face when the magnetic lock is employed. These scratches cannot be repaired due to the finish on the rim, so the rim must be replaced entirely, which can have a high cost, exceeding $1,000 USD in most cases. Further, while the metal shafts are durable in some respects, they are prone to fluctuation when the magnetic lock is activated. The magnets used to magnetically secure the metal shafts to the rim use a very powerful magnet creating a very high magnetic force, and when they're activated, they exert a strong force on the metal shafts against the rim. This exerted force can cause fluctuations in the metal shafts in various directions, often along the length of the metal shafts. These forces cause inaccuracies with the position of the camera, which in turn, causes inaccuracies and unreliable measurements in the camera alignment system. Accordingly, these inaccuracies cause vehicle wheels to be misaligned even after the camera alignment system is used.

Thus, a heretofore unaddressed need exists in the industry to address the aforementioned deficiencies and inadequacies.

### SUMMARY OF THE DISCLOSURE

Embodiments of the present disclosure provide an apparatus, system, and method for vehicle wheel alignment. Briefly described, in architecture, one embodiment of the system, among others, can be implemented as follows. A vehicle wheel alignment system has a frame member and an optical device mounted to the frame member. At least one shaft connected to the frame member, wherein the at least one shaft is positionable against a rim of the vehicle wheel, wherein the at least one shaft is constructed from a non-metal material.

The present disclosure can also be viewed as providing methods of determining an alignment of wheels of a vehicle with a vehicle wheel alignment system. In this regard, one embodiment of such a method, among others, can be broadly summarized by the following steps: positioning at least three shafts formed from a non-metal material against a rim of the vehicle wheel, wherein the at least three shafts are connected to a frame member, wherein an optical device is mounted to the frame member; locking the at least three shafts to the rim of the vehicle wheel with a magnetic securing mechanism; and determining an alignment of the vehicle wheel.

The present disclosure can also be viewed as providing methods of manufacturing non-metal alignment shafts for vehicle wheel alignment system for use with at least one of an industrial vehicle and a commercial vehicle. In this regard, one embodiment of such a method, among others, can be broadly summarized by the following steps: providing at least one non-metal material; and three-dimensionally (3D) printing the at least one non-metal material into a shaft, wherein the shaft has a rim-contacting end.

Other systems, devices, and methods may include additional structures, functions, and/or techniques for manufacturing components of the systems to better improve performance thereof. Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a cross-sectional illustration of a vehicle wheel alignment system, in accordance with a first exemplary embodiment of the present disclosure.

FIG. 1B is an illustration of the vehicle alignment system of FIG. 1A in use on a vehicle, in accordance with the first exemplary embodiment of the present disclosure.

FIG. 2A is a side view illustration of the system of FIGS. 1A-1B, in accordance with the first exemplary embodiment of the present disclosure.

FIG. 2B is a photograph of the shaft of the system of FIGS. 1A-1B, in accordance with the first exemplary embodiment of the present disclosure.

FIGS. 3A-3J illustrate side and elevated side view illustrations of the second leg of the system of FIGS. 1-2A, specifically illustrating different designs of rim-contacting ends, or different views thereof, in accordance with the first exemplary embodiment of the present disclosure.

FIGS. 4A-4B are illustrations of the shaft 40 of the system 10 of FIGS. 1A-1B, in accordance with the first exemplary embodiment of the present disclosure.

FIGS. 5A-5C illustrate elevated side and isometric view illustrations of components used to manufacture the second leg of the system of FIGS. 1-2A, in accordance with the first exemplary embodiment of the present disclosure.

FIGS. 6A-6E are elevated view illustrations of the second leg of the system showing the progression of manufacturing using a 3D printing process, in accordance with the first exemplary embodiment of the present disclosure.

FIG. 7 is an elevated illustration of the second leg of the system showing the position of the contact tip relative to the second leg, in accordance with the first exemplary embodiment of the present disclosure.

FIG. 8 is a flowchart illustrating a method of determining an alignment of wheels of a vehicle with a vehicle wheel alignment system, in accordance with the first exemplary embodiment of the disclosure.

FIG. 9 is a flowchart illustrating a method of manufacturing non-metal alignment shafts for vehicle wheel alignment system for use with at least one of an industrial vehicle and a commercial vehicle, in accordance with the first exemplary embodiment of the disclosure.

### DETAILED DESCRIPTION

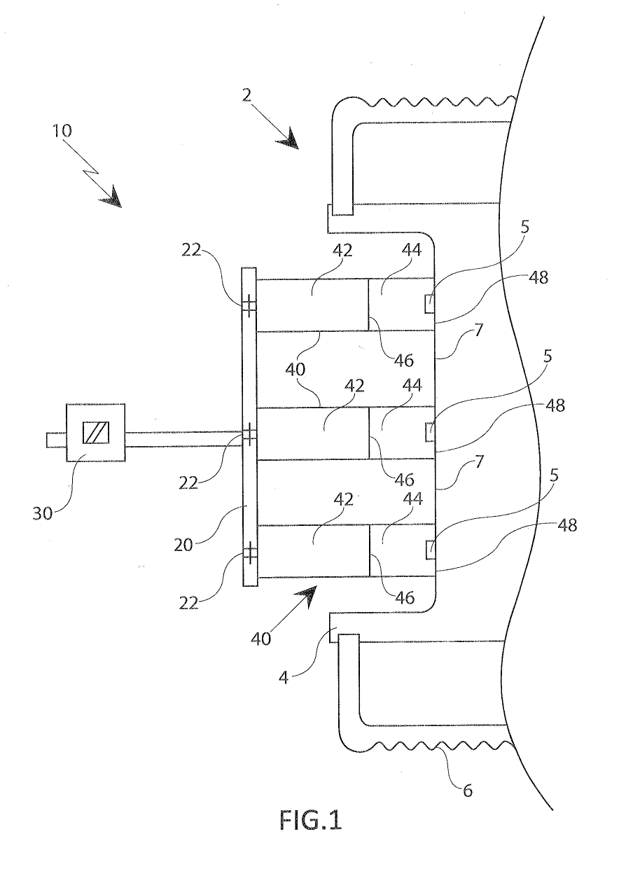

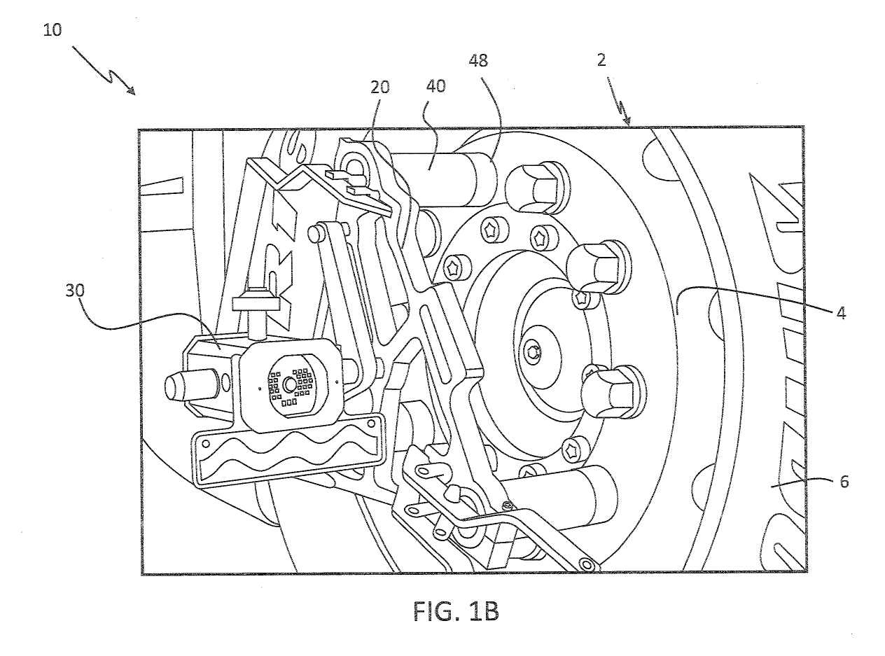

FIG. 1A is a cross-sectional illustration of a vehicle wheel alignment system 10, in accordance with a first exemplary embodiment of the present disclosure. FIG. 1B is an illustration of the vehicle alignment system 10 of FIG. 1A in use on a vehicle, in accordance with the first exemplary embodiment of the present disclosure. The vehicle wheel alignment system 10, which may be referred to simply as ‘system 10’ includes a frame member 20. An optical device 30 is mounted to the frame member 20. At least one shaft 40 is connected to the frame member 20, wherein the at least one shaft 40 is positionable against a rim 4 of the vehicle wheel 2. The at least one shaft 40 is constructed from a non-metal material.

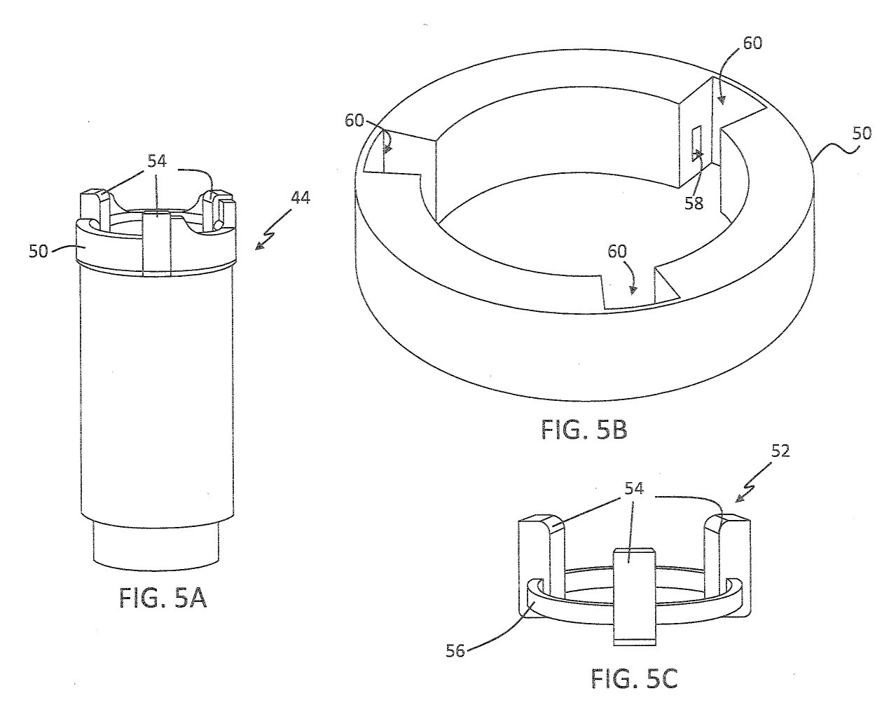

The system 10 may have particular uses to align the wheels of vehicles to the frame of the vehicle, especially the wheels of industrial or commercial vehicles, such as large trucks, tractor trailers, mass-transit vehicles, delivery trucks, or any similar vehicle. The system 10 has potential utility in all stages in the life of the vehicle, from initial construction alignment to aftermarket realignment. In contrast to conventional alignment devices which use metal shafts, usually constructed from aluminum, to mount a camera system to a vehicle's rim, the system 10 of the present disclosure has a particular benefit in the use of purely non-metal shafts to mount the frame member 20 carrying the optical device 30 to the rim 4. Among many benefits, the use of a non-metal shaft 40 prevents scratching of the vehicle rim 4 when the system 10 is mounted to the rim 4. In contrast, the metal shafts used conventionally are all formed from aluminum and have tips which abut the rim 4 face when positioned on the vehicle wheel. When the conventional system is locked to the vehicle wheel using magnetics, the application of force causes the aluminum tip of the shaft to dig into the rim face, which ultimately causes scratching on the rim. The use of non-metal shafts, in accordance with the present disclosure, does not have any metal-to-metal contact between the shafts and the rim, and therefore prevents this problem. In turn, the subject invention significantly lessens or eliminates the need to replace rims of new vehicles because they were scratched just before leaving a manufacturing facility. It is noted that the non-metal shafts 40 may be manufactured in a 3D printing process using non-metal materials, as discussed relative to FIGS. 5A-7, the specifics of which are applicable to the system 10 as described relative to FIGS. 1A-1B.

Moreover, it is noted that conventionally within the art, non-metal shafts are not present, nor contemplated, in any form; neither for preventing scratching against the expensive rims of the vehicles nor for providing sufficient rigidity and structural support within the shafts to achieve accurate alignment readings. The prior art uses metal shafts to provide the shafts with as much durability as possible, which the metal shafts provide to a certain degree. However, these material shafts have their shortcomings and continue to flex and experience fluctuations when the magnets are activated. Thus, while fully metal shafts may be sufficient for resisting certain degrees of fluctuations, they still fluctuate to a high enough degree to cause inaccuracies within the alignment systems.

As an example, Table 1, below, provides summarized results from a comparison audit of conventional metal shafts, in accordance with the prior art, and the non-metal shafts of the subject disclosure:

TABLE 1
Shaft Comparison Audit (mm/m, angular)

| | Aluminum | Aluminum | Non-metal |
|---|---|---|---|
| | Shafts, Pit #1 | Shafts, Pit #2 | Shafts, Pit #2 |
| Test Sample 1 | 1.3 | 0.6 | 2 |
| Test Sample 2 | 1.8 | 0.8 | 2.1 |
| Test Sample 3 | 1.5 | 0.9 | 2.1 |
| Test Sample 4 | 1.5 | 0.7 | 2.1 |
| Test Sample 5 | 1.5 | 0.9 | 2.3 |
| Test Sample 6 | 1.6 | 0.7 | 2.2 |
| Test Sample 7 | 1.7 | 0.8 | 2.1 |
| Test Sample 8 | 1.5 | 0.4 | 2.2 |
| Test Sample 9 | 1.6 | 0.7 | 2.2 |
| Test Sample 10 | 1.6 | 0.7 | 2.1 |
| Low | 1.3 | 0.4 | 2 |
| High | 1.8 | 0.9 | 2.3 |
| Average | 1.56 | 0.72 | 2.14 |
| Deviation from | 0.1 | 0.104 | 0.068 |
| Average | | | |

In the Shaft Comparison Audit of Table 1, wheel alignment the same, a fully stationary vehicle was audited using two different conventional systems using metal shafts and the system of the subject disclosure using non-metal shaft. Theoretically, achieving true alignment measurements from each of the tested devices would result in a zero (0) deviation from average value, since each tested device should provide the same values for each test sample. However, it was shown that with each of the conventional devices using metal shafts, there was a deviation from average which amounted to 0.1 to 0.104 mm/m. In contrast, the deviation average of the system of the subject invention having non-metal shafts was 0.068 mm/m, which is substantially far less than the conventional devices. The smaller deviation in trials correlates to industry savings in tire wear of the vehicle, improved gas mileage for the vehicle, and for the factory or manufacture of the vehicle, a reduction in warranty claims due to misalignment. Thus, it can be seen that the use of non-metal shafts in accordance with the subject disclosure can effect a substantial change in the alignment of vehicles, which in turn, can improve maintenance and operation of the vehicle.

As shown in FIGS. 1A-1B, the frame member 20 of the system 10 may include one or more structural members in a substantially planar alignment which can be positioned proximate to the wheel 2 of the vehicle, such that the shafts 40 can extend from points on the frame member 20 towards the rim 4 of the wheel 2. The frame member 20, in one example, may be designed with a substantially triangular footprint with each vertex of the triangular shape hosting a shaft 40. The frame member 20 may also include internal structural members which facilitate holding the optical device 30, among other structures. The non-metal shafts 40, as will be discussed further in detail, are connected to the frame member 20 through various arrangements which allow for precise mounting of the shafts 40 to the frame member 20. The optical device 30 may be mounted towards a center of the frame member 20 and may include any type of optical device or camera, including conventionally-used cameras or optics units.

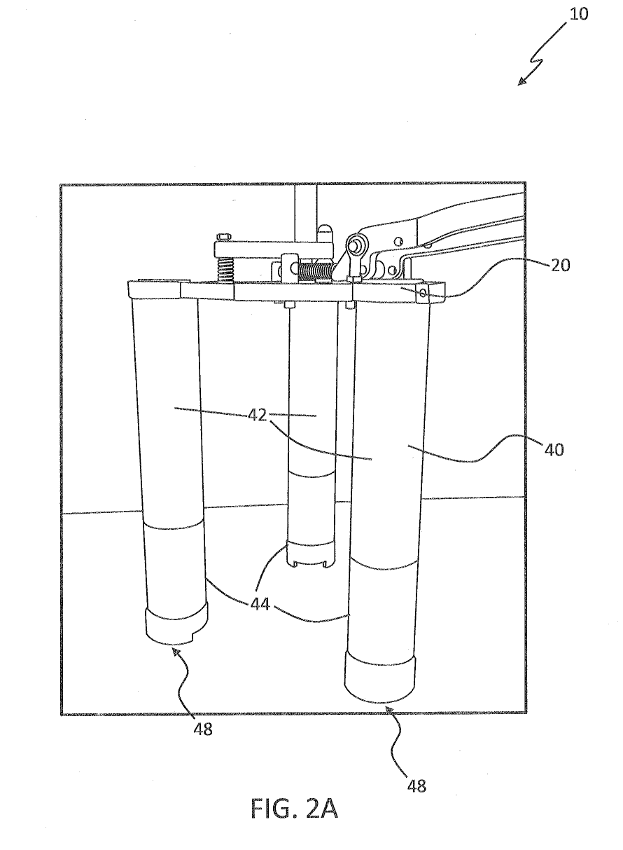

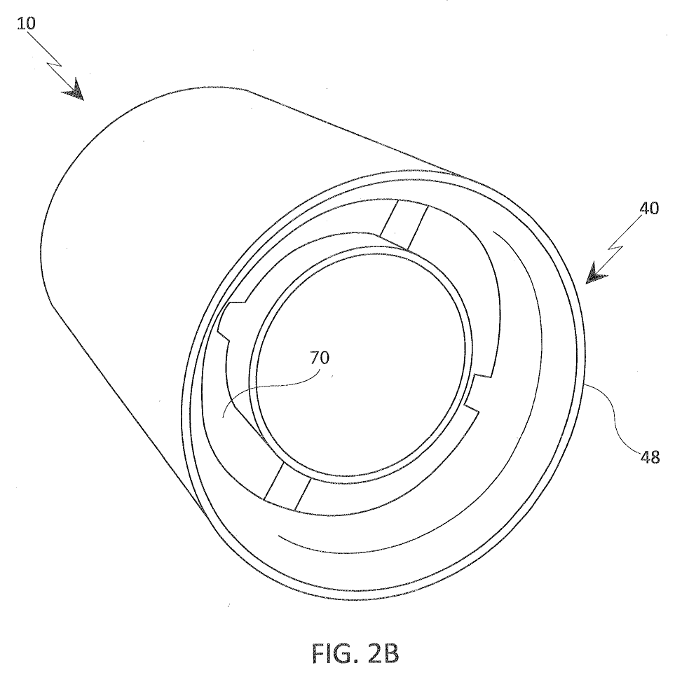

FIG. 2A is a side view illustration of the system 10 of FIGS. 1A-1B, in accordance with the first exemplary embodiment of the present disclosure. With reference to FIGS. 1-2A, the system 10 may commonly have three shafts connected to the frame 20, such that the frame can be mounted to three different locations on the vehicle rim 4, which provides stability to the optical device 30. As shown in FIGS. 1A-B, those three different locations may be locations over three different lug nuts 5 of the rim 4, such that the lug nuts 5 are positioned interior of the terminating ends of each of the shafts 40. With the terminating ends of each of the shafts 40 positioned in abutment to the face 7 of the rim 5, the frame 20 can be held in the proper position exterior of the rim 4. In other examples, more than three shafts may be used with the same positional arrangement.

FIG. 2B is a photograph of the shaft 40 of the system 10 of FIGS. 1A-1B, in accordance with the first exemplary embodiment of the present disclosure. As shown, a magnetic securing mechanism 70 may be positioned interior of the non-metal shaft 40. The magnetic securing mechanism 70 may be used to magnetically secure the frame 20 and optical device 30 (FIGS. 1-2A) to the rim 4. FIG. 2B illustrates the presence of the magnetic securing mechanism 70 within the shaft 40, positioned offset from the rim-contacting end 48 of the shaft 40 which will abut the face of the rim. The offset distance of the magnetic securing mechanism 70 may be determined based on a distance of the exterior most point of the lug nut of the wheel, such that the magnetic securing mechanism 70 can successfully retain the rim-contacting end 48 of the shaft 40 to the face of the rim.

As further shown in FIGS. 1-2A, the design and dimensions of the shafts 40 can vary, and may include two shaft pieces used together to form each shaft 40. Specifically, as each shaft 40 may include a first leg 42 and a second leg 44, where the first and second legs 42, 44 are connected together at a separable joint 46 and positioned substantially coaxial or aligned with one another. The second leg 44 includes the rim-contacting end 48 whereas the first leg 42 interfaces with the frame member 20. The use of the first leg 42 may allow for the frame 20 with the optical device 30 to be positioned in the desired location exterior of the rim 4, yet allow the rim-contacting ends 48 of the second legs 44 to achieve abutment with the face 7 of the rim 4. As can be seen, the rim 4 may include an internal cavity such that the face 7 is inset relative to an exterior face of the tires 6, which is common for vehicles using dual-tired axles. The first legs 42 may be sized accordingly based on the depth of the rim face 7. With wheel designs that do not have an inset design, such that the rim face 7 is positioned substantially flush with, or exterior of, the sidewall of the tire 6, the first leg 42 may not be needed. In this situation, the second leg 44 having the rim-contacting end 48 may be secured to the frame 20.

It is noted that when either both leg portions are used, or when just the second leg 44 is used, it requires that the leg or legs be secured properly to the frame member and to each other, if applicable. Specifically, the leg joint 46 may include threaded connections, adhesive connections, snap or friction-fit fasteners, or any combination thereof to ensure that the first and second legs 42, 44 are secured together. The leg joint 46 may also include one of the first and second legs 42, 44 having a narrowed or reduced diameter portion having a smaller diameter which fits within the a regular diameter of the other leg, where a fastener is or is not positioned at the narrowed portion. At the frame 20, the first leg 42, or second leg 44, if applicable, may be secured to the frame 20 with a clamp mechanism 22, adhesive, another securing device, or any combination thereof.

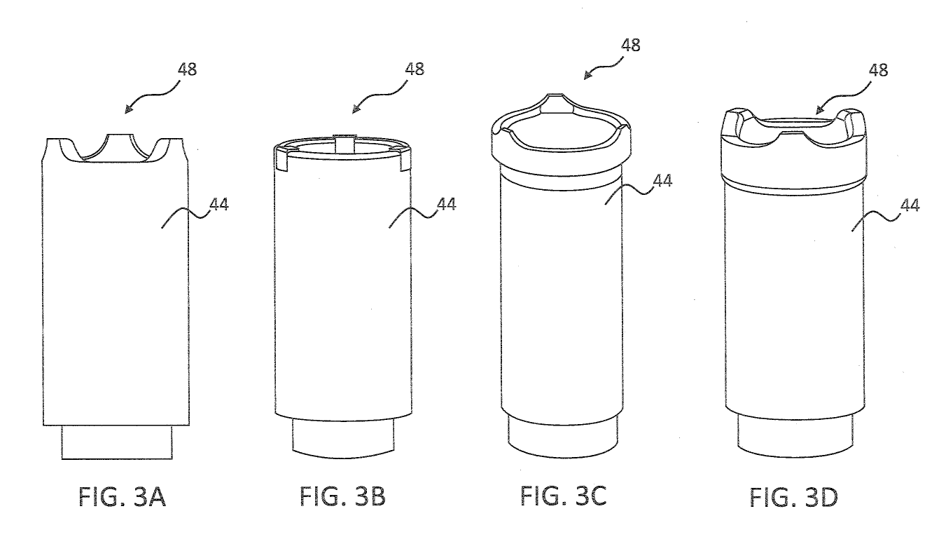

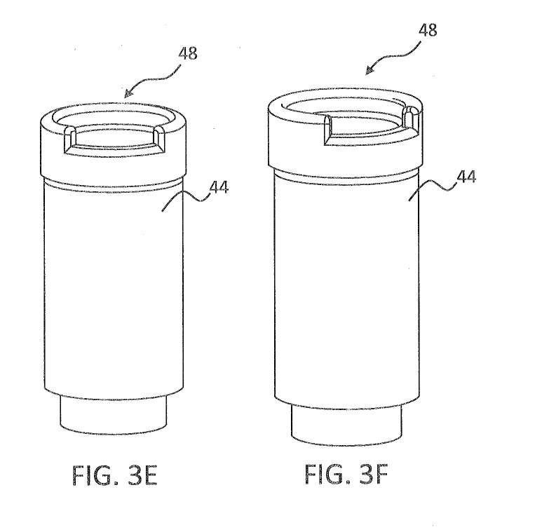

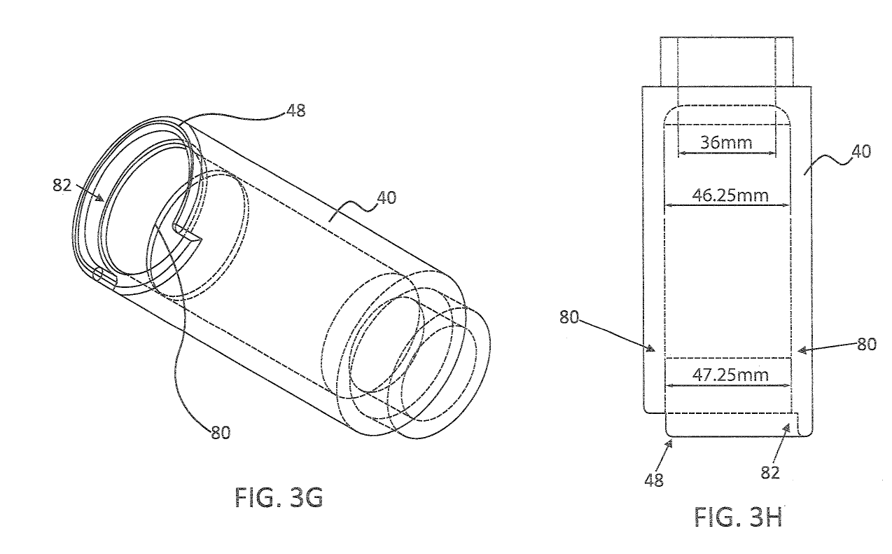

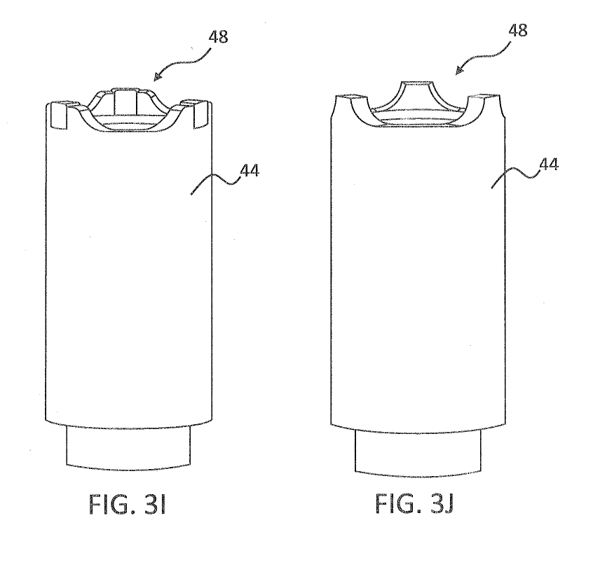

To provide the best contact possible between the shaft 40 and the face 7 of the rim 4, the second leg 44 may include a rim-contacting end 48 that has a specifically-designed face which is designed to provide a match or near-match with specific rim designs. FIGS. 3A-3J illustrate side and elevated side view illustrations of the second leg 44 of the system of FIGS. 1-2A, specifically illustrating different designs of rim-contacting ends 48, or different views thereof, in accordance with the first exemplary embodiment of the present disclosure. Many of the rim-contacting ends 48 disclosed may have non-planar rim-contact ends 48, whereby the portion of the shaft 40 which contacts the exterior surface of the rim has a non-planar or uneven contour.

For example, as shown in FIG. 3A, the shaft 40 has a rim-contacting end 48 with three points which extend outwardly from the shaft 40 body and have substantially flat surfaces for engaging with the rim. The portion of the shaft 40 positioned between the three points of the rim-contacting end 48 may extend back towards the shaft 40 body to provide appropriate clearance for structures on the rim. In FIG. 3B, the rim-contacting end 48 has three contact tips which are positioned only slightly beyond the terminating surface of the shaft 40. FIG. 3C illustrates a rim-contacting end 48 with three contact tips which extend beyond the terminating surface of the shaft and have narrowed contact points, e.g., from both along a radial dimension of the shaft 40 as well as along a thickness of the sidewall of the shaft 40. FIG. 3D illustrates another design where the rim-contacting end 48 of the shaft 40 has contact tips which extend beyond the terminating end of the shaft 40 and where the contact tips are substantially the same thickness as the sidewall of the shaft 40. Skipping to FIG. 3I, the shaft 40 is shown with a rim-contacting end 48 that includes contact points positioned slightly extended from the curved outer edges of the rim-contacting end 48, which themselves are positioned exterior of the terminating end of the shaft 40. FIG. 3J illustrates a similar design where the contact tips are integrally formed with the material of the shaft 40.

Turning back to FIGS. 3E-3H, these figures illustrate a shaft 40 with a single cutout in the rim-contacting end 48 thereof. As shown, the single cutout may be positioned along a continuous radial portion of the cylindrical shaft 40 that is substantially 20%-40% of the circumference thereof. The rim-contacting end 48 may be formed from the remaining, e.g., non-cutout, portion of the terminating end of the shaft 40. In use, the shaft 40 may be rotated as needed to angularly position the single cutout in the desired location. FIGS. 3G-3H specifically identify that the interior dimension of the shaft 40 may include an increased internal diameter at point 80, which may be particularly useful for aging magnet assembly flares. Additionally, the rim-contacting end 48 of the shaft 40 may include an enlarged contact surface area for increased balance and camera stability. This enlarged contact surface area is particularly noticeable in FIG. 3H at point 82, where it can be seen that the rim-contacting end 48 has an enlarged overall diameter than the internal diameter of the shaft 40. FIG. 3H further illustrates dimensions of the shaft 40 in accordance with one example of the subject invention.

In each of FIGS. 3A-3J, the second leg 44 includes a rim-contacting end 48 which is designed to be placed in proper abutment with a rim. Each of the different designs of the rim-contacting ends 48 may be designed to be used with a particular type of rim, such as one manufactured by a particular company or used with a particular vehicle. The end user of the system may be able to specify exactly which type of rim-contacting end 48 he or she wishes to use based on rim type the system is used with.

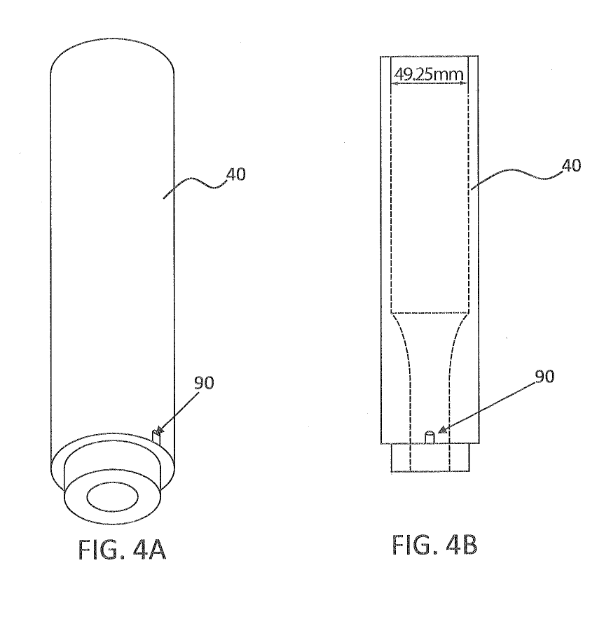

FIGS. 4A-4B are illustrations of the shaft 40 of the system 10 of FIGS. 1A-1B, in accordance with the first exemplary embodiment of the present disclosure. In particular, FIGS. 4A-4B illustrate the shaft 40 with a cutout 90 used for directional positioning. The cutout 90 may be a notch or similar feature which is formed in the exterior sidewall of the shaft 40 and is visible to a user. The cutout 90 may be included in a mating part to the shaft 40 shown, e.g., to another shaft end when more than one shaft is used. The user can radially align the shafts 40 with the cutout 90 to directionally position either of the shafts 40 as desired. FIG. 4B further illustrates dimensions of the shaft 40 in accordance with one example of the subject invention.

FIGS. 5A-5C illustrate elevated side and isometric view illustrations of components used to manufacture the second leg 44 of the system of FIGS. 1-2A, in accordance with the first exemplary embodiment of the present disclosure. Specifically, FIG. 5A illustrates the second leg 44 while FIG. 5B illustrates an end portion 50 of the second leg 44, and FIG. 5C illustrates a contact tip 52 which can form the rim-contacting end 48 of the second leg 44. As will be explained in further detail herein, it is preferable to manufacture the second leg 44 using a 3D printing device. During manufacture, the 3D printing device can be programmed to build the second leg 44 using different types of materials and using different internal construction designs, both of which can improve the use of the second leg 44. In FIGS. 5A-5C, the different components of the second leg 44 are shown independently for clarity in disclosure, but the components are preferably manufactured together using a 3D printing technique, wherein the contacting tip 52 would be positioned within the end portion 50, both of which would be positioned at the end of the second leg 44. For example, the contact tip 52 may include elongated tips 54 which are connected with an annular member 56. The annular member 56 may be positioned within an annular cavity 58 within the end portion 50, with the elongated tips 54 positioned in the elongated cavities 60 of the end portion 50. The resulting structure is positioned at the end of the second leg 44, as shown in FIG. 5A.

The differentiation between the different components of the second leg 44 may allow them to be manufactured using different materials, which are selected to improve performance of the second legs 44. For instance, in one example, the body of the second leg 44 may be manufactured from one material, whereas the contact tip 52 is manufactured from two or more materials. The end portion 50 may be manufactured from any number of materials. The difference of materials in the components can allow one component, e.g., the body of the second leg 44, to have particular material properties, while another component, e.g., the contact tip 52, has a different material property. In one example, the contact tip 52 is formed from two non-metal materials to increase its ability to prevent scratching against the rim all while providing a stable surface when the forces of magnetic clamping are applied.

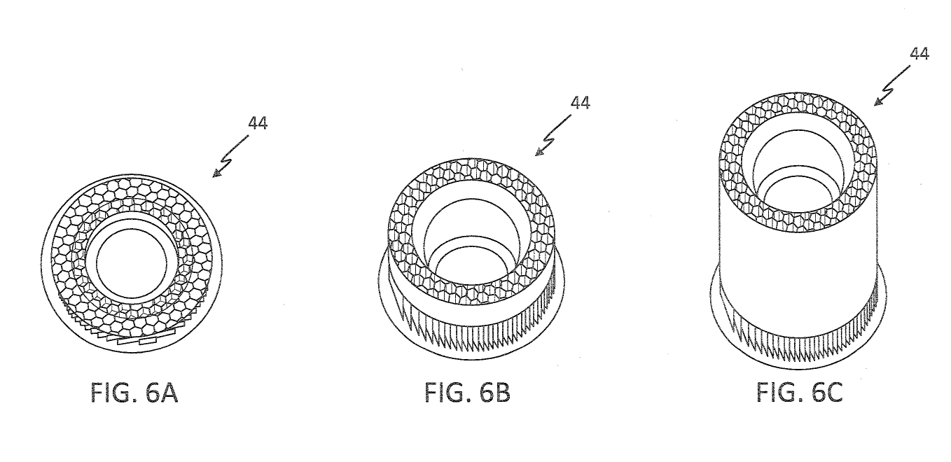

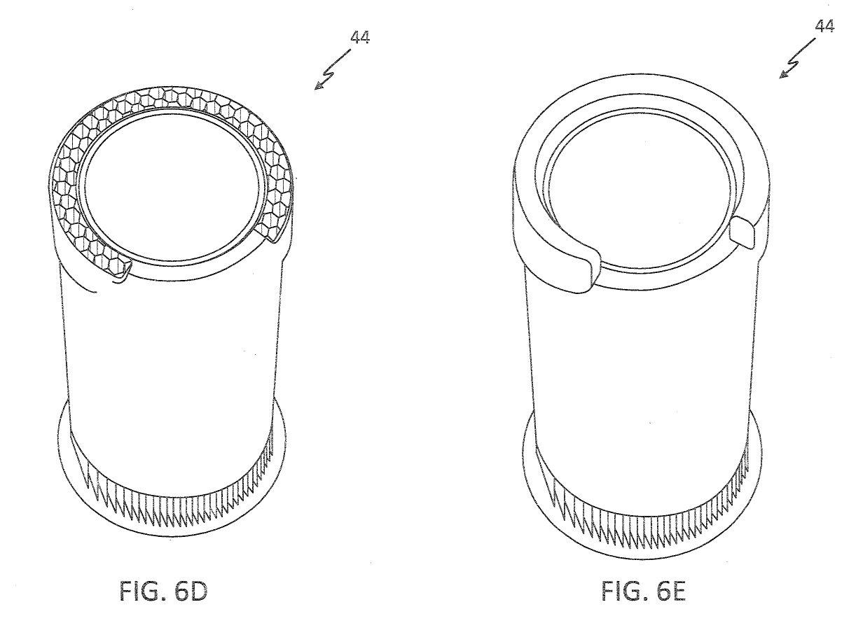

FIGS. 6A-6E are elevated view illustrations of the second leg 44 of the system 10 showing the progression of manufacturing using a 3D printing process, in accordance with the first exemplary embodiment of the present disclosure. Here, an early step in the 3D printing process can be seen in FIG. 6A, where the neck to the bottom of the second leg 44 is being printed. As shown, the internal construction of the neck may include a solid structure towards the base and a honeycomb structure above and internal thereof. The honeycomb structure can increase the anti-deflection ability of the second leg 44 when the magnetic clamping force is applied. FIG. 6B illustrates the internal fillet of the second leg 44, which shows the curvature that is used to maximize support while allowing for the internal magnet assembly movement. FIGS. 6B-6C together show the honeycomb structure throughout the interior construction of the second leg 44, however, it is noted that the honeycomb structure may include various geometric shapes beyond what it shown in these figures. FIG. 6D illustrates the 3D printing process at the beginning of manufacturing the tip of the second leg 44. A shown, the honeycomb structure may cease along a particular radial section of the second leg 44 and continue along another radial section, such that the resulting second leg 44 design shown in FIG. 6E can be achieved.

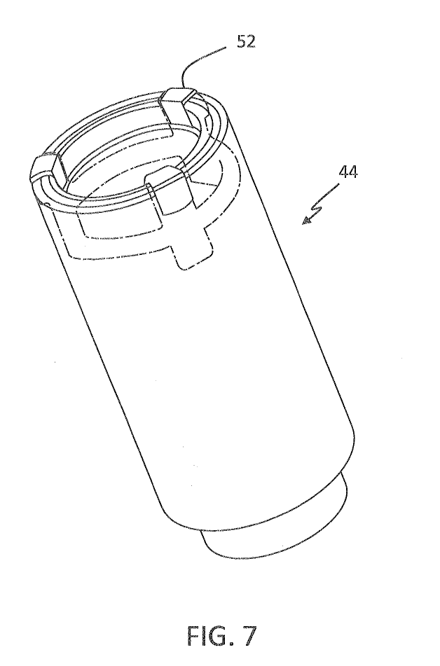

FIG. 7 is an elevated illustration of the second leg 44 of the system 10 showing the position of the contact tip 52 (FIGS. 5A-5C) relative to the second leg 44, in accordance with the first exemplary embodiment of the present disclosure. Using a similar manufacturing progression to that described relative to FIGS. 6A-6E, the design of the second leg 44 shown in FIG. 7 may be created using a 3D printer, where the contact tip 52 is manufactured from a different material or materials from the body of the second leg 44.

While the exact materials of manufacturing the second leg 44 (and the first leg 42, if used) may vary, it will be manufactured to be a non-scratching surface. To this end, the manufacture will not include the use of metals as is used in the conventional art. In one example of manufacture using a 3D printer, the second leg 44 is formed from a polylactic acid with a polymer foam infill. The form is created using a heated nozzle head to extrude the plastic into the form. An extruder head heated at 215 degrees Celsius will push filament with a diameter of 1.75 millimeters with a density of 100 kg/m³ is fed through an orifice heated at 215° C. The extruder will travel at a rate of 100 millimeters per second in the x/y direction and will create a layer with a height of 0.3 millimeters. The base in which the form is created will drop at a rate of 15 millimeters per second from the extrusion head. Each layer will be created within a 15 second window to create the optimal adhesion between layers. The nozzle diameter in which the plastic will be extruded through can range from 0.4-0.6 mm orifice. The form is then injected with a polymer foam and agitated with a water mixture for two hours to insure proper distribution and even expansion throughout. Once the foam has dried the entire assembly is then dipped in an acetone bath to smooth and bond all of the outside layers of the piece. Any number of variations, processes, or steps may be used with this exemplary description of 3D printing of the second leg 44.

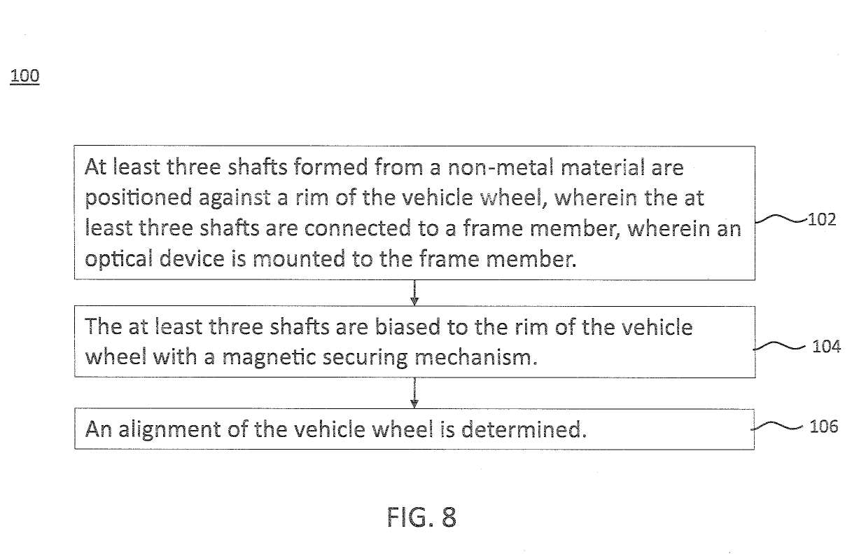

FIG. 8 is a flowchart 100 illustrating a method of determining an alignment of wheels of a vehicle with a vehicle wheel alignment system, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, at least three shafts formed from a non-metal material are positioned against a rim of the vehicle wheel, wherein the at least three shafts are connected to a frame member, wherein an optical device is mounted to the frame member. The at least three shafts are biased to the rim of the vehicle wheel with a magnetic securing mechanism (block 104). An alignment of the vehicle wheel is determined (block 106). The method may further include any of the steps, functions, features, or components described herein relative to any other figure.

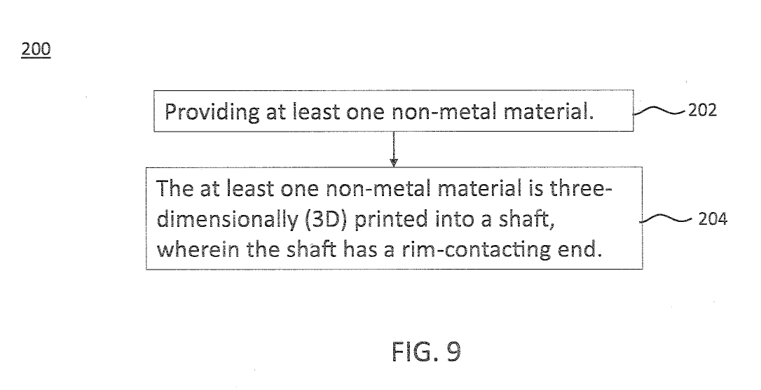

FIG. 9 is a flowchart 200 illustrating a method of manufacturing non-metal alignment shafts for vehicle wheel alignment system for use with at least one of an industrial vehicle and a commercial vehicle, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, the method of manufacturing non-metal alignment shafts for vehicle wheel alignment system for use with at least one of an industrial vehicle and a commercial vehicle includes providing at least one non-metal material. The at least one non-metal material is three-dimensionally (3D) printed into a shaft, wherein the shaft has a rim-contacting end (block 204). The method may further include any of the steps, functions, features, or components described herein relative to any other figure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment of the disclosure without departing substantially from the spirit and principles of the disclosure. All such modifications and variations are intended to be included herein within the scope of this disclosure and the present disclosure and protected by the following claims.

What is claimed is:

1. A vehicle wheel alignment system comprising:
a frame member;
an optical device mounted to the frame member; and
at least one shaft connected to the frame member, wherein the at least one shaft is positionable against a rim of the vehicle wheel, wherein the at least one shaft is constructed from a non-metal material.

2. The vehicle wheel alignment system of claim 1, wherein the at least one shaft has a sidewall with a honeycomb structure forming at least a portion thereof.

3. The vehicle wheel alignment system of claim 2, wherein the honeycomb structure is formed using a three-dimensional (3D) printing process.

4. The vehicle wheel alignment system of claim 1, further comprising a magnetic securing mechanism positioned at least partially within the at least one shaft, wherein a rim-contact end of the at least one shaft is biased against the rim of the vehicle wheel when the magnet securing mechanism is activated.

5. The vehicle wheel alignment system of claim 1, wherein the at least one shaft is formed from a first leg and a second leg, wherein the first leg is connected to the second leg with a separable joint, and wherein the first and second leg are substantially coaxial.

6. The vehicle wheel alignment system of claim 5, wherein one of the first and second legs has a reduced diameter portion substantially at the separable joint, wherein the reduced diameter portion of one of the first and second legs is positionable within the other of the first and second legs.

7. The vehicle wheel alignment system of claim 1, wherein the at least one shaft has a non-planar rim-contact end.

8. The vehicle wheel alignment system of claim 7, wherein the non-planar rim-contact end further comprises at least one of:
at least three contact tips which extend outwardly from a body of the at least one shaft; and
a single cutout positioned along a continuous radial portion of the at least one shaft.

9. The vehicle wheel alignment system of claim 7, wherein the at least one shaft has the non-planar rim-contact end formed with at least two contact tips, wherein the at least two contact tips are formed from a first non-metal material and a body of the at least one shaft is formed from a second non-metal material, wherein the first non-metal material is different from the second non-metal material.

10. A method of determining an alignment of wheels of a vehicle with a vehicle wheel alignment system, the method comprising the steps of:
positioning at least three shafts formed from a non-metal material against a rim of the vehicle wheel, wherein the at least three shafts are connected to a frame member, wherein an optical device is mounted to the frame member;
locking the at least three shafts to the rim of the vehicle wheel with a magnetic securing mechanism; and
determining an alignment of the vehicle wheel.

11. The method of claim 10, wherein the at least three shafts have sidewalls with a honeycomb structure forming at least a portion of the sidewalls thereof.

12. The method of claim 10, wherein the magnetic securing mechanism is positioned at least partially within the at least one shaft, wherein a rim-contact end of the at least one shaft is biased against the rim of the vehicle wheel when the magnet securing mechanism is activated.

13. The method of claim 10, wherein the at least three shafts are each formed from a first leg and a second leg, wherein the first leg is connected to the second leg with a separable joint, and wherein the first and second leg are substantially coaxial.

14. The method of claim 13, wherein one of the first and second legs has a reduced diameter portion substantially at the separable joint, wherein the reduced diameter portion of one of the first and second legs is positionable within the other of the first and second legs.

15. The method of claim 10, wherein the at least three shafts each have a non-planar rim-contact end, wherein the non-planar rim-contact end further comprises at least one of:
at least three contact tips which extend outwardly from a body of the at least one shaft; and
a single cutout positioned along a continuous radial portion of the at least one shaft.

16. The method of claim 10, wherein the at least three shafts each have a non-planar rim-contact end having at least two contact tips, wherein the at least two contact tips are formed from a first non-metal material and a body of the at least one shaft is formed from a second non-metal material, wherein the first non-metal material is different from the second non-metal material.

17. A method of manufacturing non-metal alignment shafts for vehicle wheel alignment system for use with at least one of an industrial vehicle and a commercial vehicle, the method comprising the steps of:
providing at least one non-metal material; and
three-dimensionally (3D) printing the at least one non-metal material into a shaft, wherein the shaft has a rim-contacting end.

18. The method of claim 17, wherein three-dimensionally (3D) printing the at least one non-metal material into the shaft further comprises forming at least a portion of a sidewall of the shaft with a honeycomb structure.

19. The method of claim 17, further comprising forming the rim-contacting end as a non-planar rim-contact end having at least two contact tips, wherein the at least two contact tips are 3D printed from a first non-metal material and a body of the at least one shaft is 3D printed from a second non-metal material, wherein the first non-metal material is different from the second non-metal material.

20. The method of claim 19, wherein the at least two contact tips are connected to an annular member, wherein the annular member is formed from the first non-metal material, and wherein the annular member is positioned within an annular cavity formed from the second non-metal material.
